(19) United States
(12) Patent Application Publication
(10) Pub. No.: US 2022/0350453 A1
(43) Pub. Date: Nov. 3, 2022

(54) DISPLAY CONTROL METHOD, STORAGE MEDIUM, AND DISPLAY CONTROL DEVICE

(71) Applicant: Seiko Epson Corporation, Tokyo (JP)

(72) Inventor: Yusuke YAMADA, Shiojiri-shi (JP)

(21) Appl. No.: 17/660,490

(22) Filed: Apr. 25, 2022

(30) Foreign Application Priority Data
Apr. 28, 2021 (JP) 2021-075755

(51) Int. Cl. G06F 3/0483; G06F 3/04815; H04N 1/00

(52) U.S. Cl. CPC G06F 3/0483; G06F 3/04815; H04N 1/00445; G06F 3/0485

(57) ABSTRACT

Disclosed is a display control method for displaying, along a virtual axis, a given number of images in an image bundle including a first area and a second area. The display control method includes arranging two adjacent images in the first area apart with a first interval, arranging two adjacent images in the second area apart with a second interval in an overlapping manner, and hiding some of the images in the second area when the given number is greater than a predetermined first threshold number. The first area includes a first number of images, and the first number is less than the given number. The second area includes a second number of images, the second number is less than the given number, and the first interval is greater than the second interval.

The present application is based on, and claims priority from JP Application Serial Number 2021-075755, filed Apr. 28, 2021, the disclosure of which is hereby incorporated by reference herein in its entirety.

### BACKGROUND

### 1. Technical Field

The present disclosure relates to a display control method, a storage medium, and a display control device.

### 2. Related Art

There is known a display method for displaying an image bundle in which a plurality of images are arranged. JP-A-2021-15470 describes a display method for displaying an image bundle in which a plurality of images are arranged on a virtual axis, and providing a display area in which images are displayed at given intervals in an overlapping manner and a display area in which images are displayed at intervals wider than the given intervals such that the images do not overlap.

However, in the method described in JP-A-2021-15470, the number of images included in the display area in which images are displayed in an overlapping manner increases with an increase in the number of images included in the image bundle. This affects a displayed image representing a plurality of images included in this display area, thereby decreasing the visibility of the images included in the display area.

### SUMMARY

A display control method according to an aspect of the present disclosure is a display control method for displaying, along a virtual axis, a given number of images in an image bundle including a first area and a second area. The display control method includes arranging two adjacent images in the first area apart with a first interval, arranging two adjacent images in the second area apart with a second interval in an overlapping manner, and hiding some of the images in the second area when the given number is greater than a predetermined first threshold number. The first area includes a first number of the images, and the first number is less than the given number. The second area includes a second number of the images, the second number is less than the given number, and the first interval is greater than the second interval.

A non-transitory computer-readable storage medium according to another aspect of the present disclosure is a non-transitory computer-readable storage medium storing a display control program that, when executed by a computer of a display control device, causes the computer to function as a determiner configured to determine whether the number of images included in an image bundle to be displayed is greater than or equal to a first threshold number, and a display controller configured to display an image bundle including a first area in which a first number of images are arranged apart, and a second area in which a second number of images are arranged apart with a second interval in an overlapping manner. The first number is less than the number of images. The second number is less than the number of images. The display controller arranges two adjacent images of the images in the first area apart with a first interval. The first interval is greater than the second interval. The display controller hides some of the images in the second area when the determiner determines that the number of images is greater than or equal to the first threshold number.

A display control device according to a further aspect of the present disclosure is a display control device including an obtainer configured to obtain an image bundle including a given number of images, a determiner configured to determine whether the given number is greater than or equal to a predetermined first threshold number, and a display controller configured to display an image bundle including a first area in which a first number of images are arranged apart, and a second area in which a second number of images are arranged apart with a second interval in an overlapping manner. The first number is less than the given number. The second number is less than the given number. The display controller arranges two adjacent images in the first area apart with a first interval. The first interval is greater than the second interval. The display controller hides some of the images in the second area when the determiner determines that the given number is greater than or equal to the first threshold number.

### BRIEF DESCRIPTION OF THE DRAWINGS

FIG. 1 is a diagram illustrating an example of a configuration of a smartphone.

FIG. 2 is a screen diagram illustrating an example of a screen on which an image bundle is displayed.

FIG. 3 is a diagram illustrating an example of arrangement of edge index marks.

FIG. 4 is a screen diagram illustrating an example of edge index marks in a second area.

FIG. 5 is a screen diagram illustrating an example of a scroll operation for the image bundle.

FIG. 6 is a screen diagram illustrating an example of the image bundle after the scroll operation has been performed.

FIG. 7 is a flowchart illustrating an example of a process of a controller.

FIG. 8 is a screen diagram illustrating another example of edge index marks in the second area.

### DESCRIPTION OF EXEMPLARY EMBODIMENTS

The present embodiment will be described below with reference to the accompanying drawings.

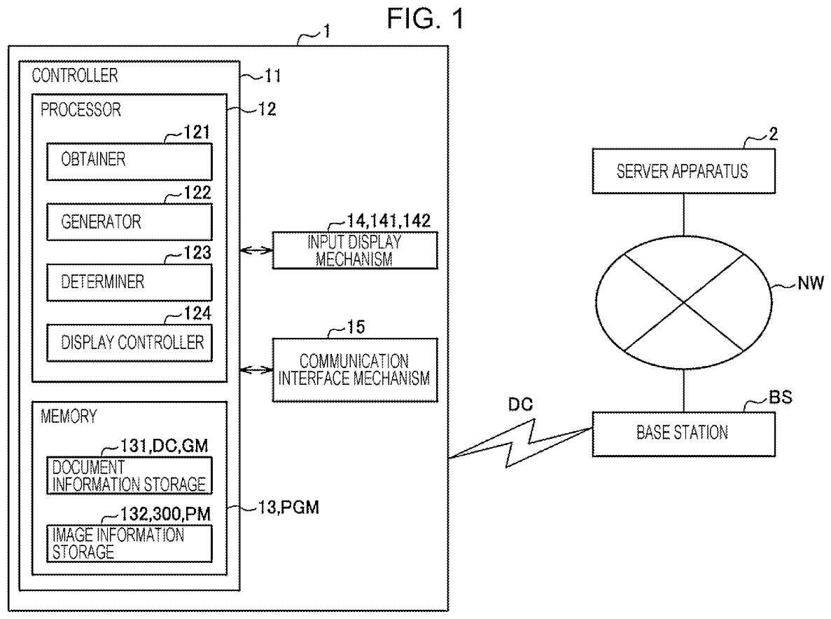

FIG. 1 is a diagram illustrating an example of a configuration of a smartphone 1 according to the present embodiment.

The smartphone 1 is communicatively coupled to a server apparatus 2 over a base station BS and a network NW.

The smartphone 1 is communicatively coupled to the base station BS via Wi-Fi (registered trademark) or another wireless communication.

The server apparatus 2 and each of the base stations BS are communicatively coupled to each other over the network NW via Ethernet (registered trademark) or another wireless communication.

The network NW is, for example, the Internet.

Although the present embodiment illustrates that the network NW is the Internet, the present disclosure is not limited to this. The network NW may be a local area network (LAN) or may be a wide area network (WAN).

The server apparatus 2 stores document information DC.

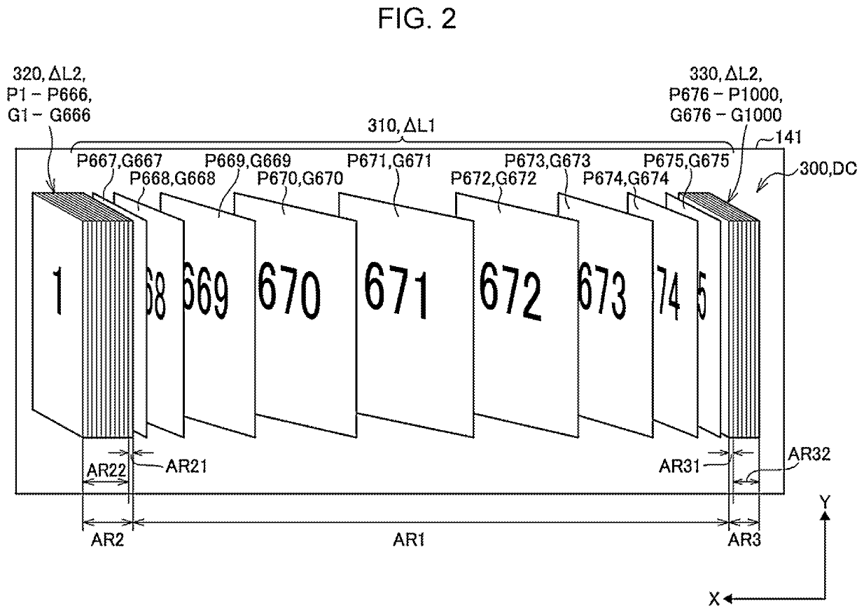

The smartphone 1 obtains the document information DC from the server apparatus 2. The smartphone 1 displays the document information DC as an image bundle 300 illustrated in FIG. 2.

The smartphone 1 corresponds to an example of a display control device.

Although the present embodiment illustrates that the smartphone 1 obtains the document information DC from the server apparatus 2, the present disclosure is not limited to this. The smartphone 1 may obtain the document information DC from another smartphone. The smartphone 1 may obtain the document information DC from a personal computer, a tablet computer, or another device.

The smartphone 1 includes a controller 11, an input display mechanism 14, and a communication interface mechanism 15.

The controller 11 controls components of the smartphone 1.

The input display mechanism 14 is a touch panel used to receive operations from a user and to display various images. The input display mechanism 14 includes a display 141, such as a liquid crystal display (LCD), and a touch sensor 142.

The display 141 displays various images according to instructions from the controller 11. The touch sensor 142, which is formed integrally with the display surface of the display 141, receives a touch operation from the user.

The communication interface mechanism 15, which includes an antenna, a radio frequency (RF) circuit, an encoder, a decoder, and other components, communicates with the server apparatus 2 via Wi-Fi or the like according to an instruction from the controller 11.

The controller 11 is a controller including the processor 12 and a memory 13.

The memory 13 is a storage device that stores, in a non-volatile manner, programs executed by the processor 12 and data. The memory 13 is constituted by a magnetic storage device such as a hard disk drive (HDD), a semiconductor storage device such as a solid state drive (SSD), a semiconductor memory element such as a flash read-only memory (ROM), or another type of non-volatile storage device. The memory 13 may include a random-access memory (RAM) constituting a work area of the processor 12. The memory 13 stores data that is processed by the controller 11 and a control program PGM that the processor 12 executes.

The controller 11 corresponds to an example of a computer.

The control program PGM corresponds to an example of a display control program.

The processor 12 may be constituted by a single processor, or there may be a configuration in which a plurality of processors function as the processor 12. The processor 12 executes the control program PGM to control components of the smartphone 1.

In the present embodiment, the processor 12 executes the control program PGM to control components of the smartphone 1. However, the controller 11 may be constituted by an application-specific integrated circuit (ASIC) and cause processes to be executed by using functions implemented in the ASIC. The controller 11 may be constituted by a signal processing circuit and may perform processes by performing signal processing using the signal processing circuit.

The controller 11 includes an obtainer 121, a generator 122, a determiner 123, a display controller 124, a document information storage 131, and an image information storage 132. The controller 11 functions as the obtainer 121, the generator 122, the determiner 123, and the display controller 124 through execution of the control program PGM by the processor 12. The controller 11 causes the memory 13 to function as the document information storage 131 and the image information storage 132 through execution of the control program PGM by the processor 12.

The control program PGM corresponds to an example of a control program.

The document information storage 131 stores the document information DC to be displayed on the display 141. The document information DC is in portable document format (PDF) or joint photographic experts group (JPEG) format. The document information DC is obtained from the server apparatus 2 by the obtainer 121 and is stored in the document information storage 131. The document information DC includes a given number N of pieces of page information GM. The page number M is an integer from 1 to N. The given number N is, for example, 1000.

The image information storage 132 stores various images to be displayed on the display 141. The image information storage 132 stores an image bundle 300 illustrated in FIG. 2. The image bundle 300 is generated by the generator 122 and is stored in the image information storage 132.

The obtainer 121 obtains the document information DC from the server apparatus 2. The document information DC includes the given number N of pieces of page information GM.

The obtainer 121 causes the document information DC to be stored in the document information storage 131.

The given number N corresponds to an example of the number of images.

The generator 122 generates various images to be displayed on the display 141.

The generator 122 generates the image bundle 300 illustrated in FIG. 2. The image bundle 300 is an image representing the document information DC. The generator 122 causes the generated image bundle 300 to be stored in the image information storage 132. The image bundle 300 includes the given number N of page images PM. The page image PM is an image representing the page information GM. The page number M is an integer from 1 to N. The given number N represents the number of page images PM included in the image bundle 300.

In the description given below, the page images PM may be described as images PM.

With reference to FIG. 2, the image bundle 300 will be described in further detail.

The determiner 123 determines whether the given number N is greater than or equal to a first threshold number NS1. The first threshold number NS1 is, for example, 300.

The display controller 124 displays the image bundle 300 illustrated in FIG. 2 on the display 141.

With reference to FIG. 2, a process of the display controller 124 is described below by way of example.

FIG. 2 is a screen diagram illustrating an example of a screen on which the image bundle 300 is displayed. FIG. 2 illustrates the case where the given number N is greater than or equal to the first threshold number NS1.

The display controller 124 displays, along a virtual axis parallel to the X-axis, the given number N of images PM in the image bundle 300 including a first area AR1 and a second area AR2. The display controller 124 may display, along the virtual axis, the given number N of images PM in the image bundle 300 consisting of the first area AR1, the second area AR2, and a third area AR3. The given number N is, for example, 1000.

When the display 141 is rectangular, the X-axis is parallel to a first side of the display 141. The Y-axis is perpendicular to the X-axis and is parallel to a second side, perpendicular to the first side, of the display 141.

As illustrated in FIG. 2, the third area AR3, the first area AR1, and the second area AR2 are arranged in this order along the positive direction of the X-axis. The positive direction of the X-axis is the left direction in FIG. 2.

The first area AR1 is arranged in a center portion of the display 141.

The second area AR2 is arranged to the left of the first area AR1. The third area AR3 is arranged to the right of the first area AR1.

In each of the second area AR2 and the third area AR3 of the image bundle 300, the images PM adjacent to each other are aligned at equal intervals in a partially overlapping manner. The equal interval may have an error corresponding to the thickness of a ridge line representing an edge surface of the image PM. In the first area AR1 of the image bundle 300, the images PM adjacent to each other are aligned in a partially overlapping manner so as to enable the image faces of the images PM adjacent to each other to be visually recognized.

Each of the images PM is arranged along a first virtual axis extending in a first direction of the display screen of the display 141. The first direction is the left and right direction in FIG. 2. Each of the images PM is displayed with rotation around the second virtual axis, which intersects the first virtual axis and extends in a second direction of the display screen of the display 141, and with further rotation around the first virtual axis. The second direction is the up and down direction in FIG. 2.

Each of the images PM is rotated around the first virtual axis and the second virtual axis. When the user faces the display 141, the image bundle 300 comprised of the plurality of images PM is deformed in a manner that enables the user to take a bird's eye view of the image bundle 300. The plurality of images PM included in the image bundle 300 are deformed, resulting in pages being viewed in a manner similar to that in which the image bundle 300 is viewed from diagonally above and a bird's eye view thereof is taken.

The display controller 124 displays, in the first area AR1, a first image bundle 310 in which a first number N1, less than the given number N, of images PM are arranged apart. The two adjacent images PM included in the first image bundle 310 are arranged at a first interval ΔL1. The first number N1 is nine in FIG. 2. The first image bundle 310 is comprised of images P667 to P675. The first number N1 of images PM are the images P667 to P675.

The image P667 represents page information G667 of page 667 of the document information DC. The image P668 represents page information G668 of page 668 of the document information DC. The image P669 represents page information G669 of page 669 of the document information DC. The image P670 represents page information G670 of page 670 of the document information DC. The image P671 represents page information G671 of page 671 of the document information DC. The image P672 represents page information G672 of page 672 of the document information DC. The image P673 represents page information G673 of page 673 of the document information DC. The image P674 represents page information G674 of page 674 of the document information DC. The image P675 represents page information G675 of page 675 of the document information DC.

As mentioned above, each image PM is denoted such that a number, which designates the page number M corresponding to the image PM, is appended at the end.

In FIG. 2, the image P670 includes a character image “670”. The image P671 includes a character image “671”. The image P672 includes a character image “672”.

In FIG. 2, the character images “670” to “672” are displayed in a readable manner. At least some of the character images “668” to “675” are also displayed in a readable manner.

The first interval ΔL1 indicates the interval between the images PM adjacent to each other among the images P667 to P675. The interval between the images PM adjacent to each other indicates the distance in the X-axis direction between the respective center positions of the images PM adjacent to each other.

The first interval ΔL1 increases as the display position of the image PM approaches the center in the X-axis direction of the first area AR1.

The interval between the image P670 and the image P671 is equal to the interval between the image P671 and the image P672. The interval between the image P672 and the image P673 is less than the interval between the image P671 and the image P672. The interval between the image P673 and the image P674 is less than the interval between the image P672 and the image P673. The interval between the image P674 and the image P675 is less than the interval between the image P673 and the image P674.

The display controller 124 displays, in the second area AR2, a second image bundle 320 in which a second number N2, less than the given number N, of images PM are arranged apart with a second interval ΔL2, less than the first interval ΔL1, in an overlapping manner.

The second number N2 is, for example, 666.

The second image bundle 320 represents an image bundle of images P1 to P666. The second image bundle 320 includes page information G1 to G666.

The display controller 124 displays, in the third area AR3, a third image bundle 330 in which a third number N3, less than the given number N, of images PM are arranged apart with the second interval ΔL2, less than the first interval ΔL1, in an overlapping manner.

The third number N3 is, for example, 325.

The third image bundle 330 represents an image bundle of images P676 to P1000. The third image bundle 330 includes page information G676 to G1000.

When the given number N is greater than the predetermined first threshold number NS1, the display controller 124 hides some of the images PM in each of the second area AR2 and the third area AR3.

In FIG. 2, since the given number N is 1000 and the first threshold number NS1 is 300, the display controller 124 hides some of the images PM in each of the second area AR2 and the third area AR3.

The images PM in the second area AR2 and the images PM in the third area AR3 are processed in the same way. Therefore, the images PM in the second area AR2 will be mainly described below while the images PM in the third area AR3 will not be described.

The display controller 124 hides some of the images PM in the second area AR2 according to a predetermined rule. The display controller 124 omits a drawing process of the images PM to be hidden.

The display controller 124 hides some of the images PM in the second area AR2 without performing a drawing process of these images PM and causes a difference between the number of odd-numbered images PM to be displayed and the number of even-numbered images PM to be displayed, among the second number N2 of the images, to be less than or equal to a second threshold number NS2. The second threshold number NS2 is, for example, two.

The display controller 124 may display the images PM included in the second area AR2 for every preset odd number ND of images PM and hide the other images PM. In this case, odd-numbered images PM and even-numbered images PM are alternately selected as the images PM to be displayed. The odd number ND is, for example, three.

In such a manner, the second image bundle 320 is displayed in which some of the images PM in the second area AR2 are hidden. This may reduce the display operations for the second image bundle 320. The display time for the second image bundle 320 may be reduced. Hiding some of the images PM in the second area AR2 results in a decrease in the number of images PM displayed in the second area AR2. This may reduce the decrease in visibility of the second image bundle 320.

According to the predetermined rule, the display controller 124 hides, of the images PM included in the second area AR2, the images PM apart from the image PM closest to the first area AR1 by a third threshold number NS3 or more of images PM, without performing a drawing process of the hidden images PM. For example, the third threshold number NS3 is, for example, 11.

The display controller 124 performs a drawing process of, among the images PM included in the second area AR2, up to ((the third threshold number NS3)−1) of images PM, that is, up to 10 images PM from the image PM closest to the first area AR1 and displays the up to 10 images PM.

In FIG. 2, the second area AR2 consists of a display area AR21 and a partially hidden area AR22. In the display area AR21, the display controller 124 displays the images PM. In the partially hidden area AR22, the display controller 124 displays the images PM included in the second area AR2 for every odd number ND of images PM and hides the other images PM in the second area AR2.

The display area AR21 is comprised of 10 images PM. That is, 10 images PM, the images P657 to P666, are displayed in the display area AR21.

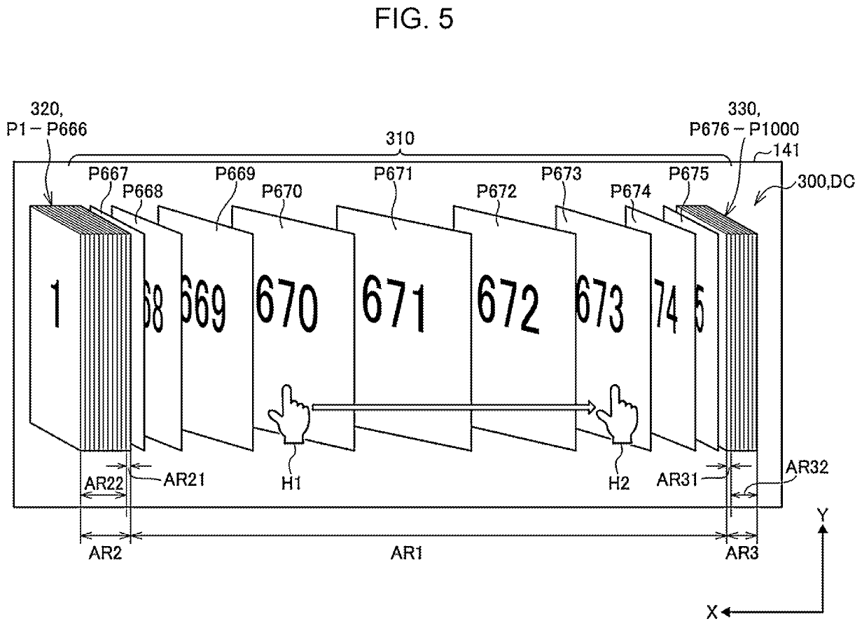

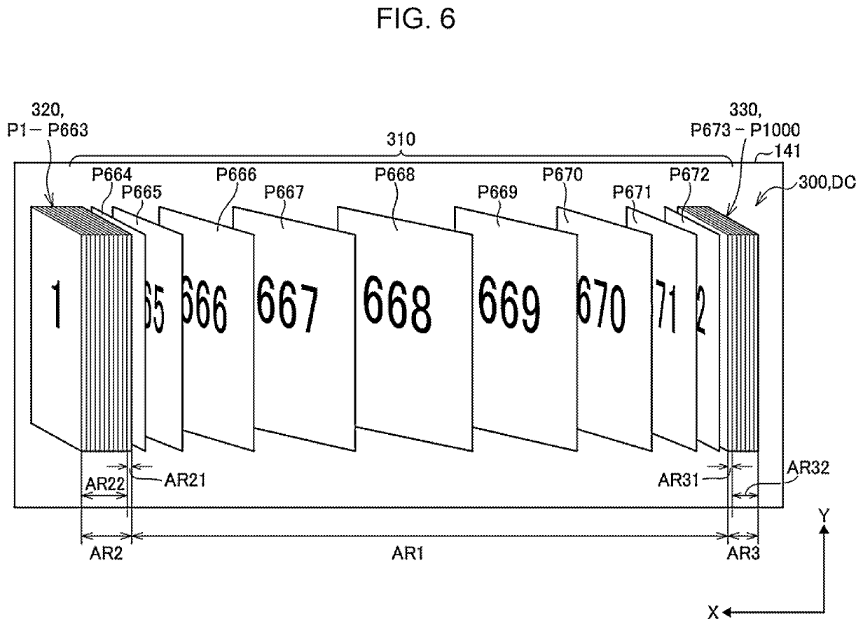

The display area AR21 is displayed by the display controller 124. As will be described with reference to FIGS. 5 and 6, when the user moves some of the images PM displayed in the second area AR2 to the first area AR1, the display controller 124 may inhibit the hidden images PM from being moved and displayed in the first area AR1. Accordingly, natural images may be displayed.

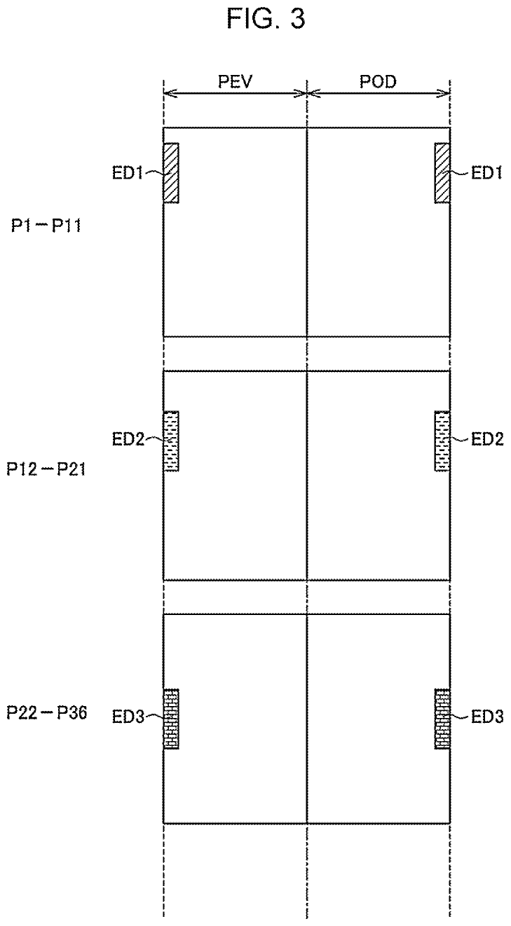

Next, with reference to FIGS. 3, 4, and 8, the effects of causing some of the images PM in the second area AR2 to be hidden by displaying the images PM included in the second area AR2 for every odd number ND of images PM will be described.

FIG. 3 is a diagram illustrating an example of arrangement of edge index marks ED.

FIG. 3 illustrates the case where the document information DC corresponds to a document, such as a dictionary or instruction manual, to which edge index marks ED are attached. FIG. 3 illustrates the case where an edge index mark ED is attached to an even-numbered page image PEV at its left edge and the edge index mark ED is attached to an odd-numbered page image POD at its right edge.

In FIG. 3, first edge index marks ED1 are attached to the images P1 to P11.

Second edge index marks ED2 are attached to the images P12 to P21. The second edge index marks ED2 are positioned lower than the first edge index marks ED1.

Third edge index marks ED3 are attached to the images P22 to P36. The third edge index marks ED3 are positioned lower than the second edge index marks ED2.

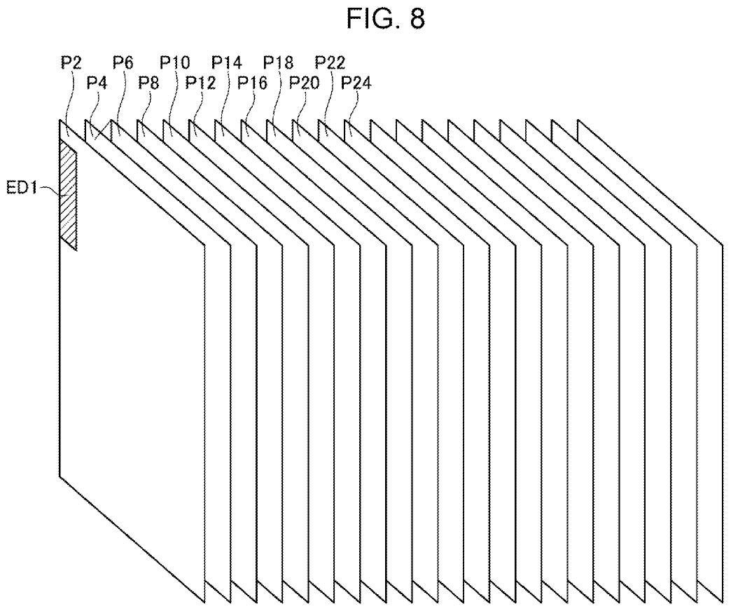

FIG. 8 is a screen diagram illustrating an example of the edge index marks ED in the second image bundle 320 displayed in the second area AR2.

FIG. 8 illustrates the case where the display controller 124 displays the images PM included in the second area AR2 for every even number NE of images PM. The even number NE is, for example, two.

When the images PM included in the second area AR2 are displayed for every even number NE of images PM, only the images PM at even-numbered pages are displayed as illustrated in FIG. 8.

As illustrated in FIG. 8, as the second image bundle 320, the images P2, P4, P6, P8, P10, P12, P14, P16, P18, P20, P22, and P24 are displayed successively from left to right.

As illustrated for the image P2, the first edge index mark ED1 attached to the image P2 is arranged in the back of the screen. The first edge index marks ED1 attached to the images P4, P6, P8, and P10 are arranged in the back of the screen and are therefore invisible. The second edge index marks ED2 attached to the images P12, P14, P16, P18, and P20 are arranged in the back of the screen and are therefore invisible. The third edge index marks ED3 attached to the image P22, the image P24, and other images PM are arranged in the back of the screen and are therefore invisible.

When, as illustrated in FIG. 8, the images PM included in the second area AR2 are displayed for every even number NE of images PM, the edge index marks ED are arranged in the back of the screen and are therefore invisible. The visibility of the edge index marks ED of the second image bundle 320 is decreased.

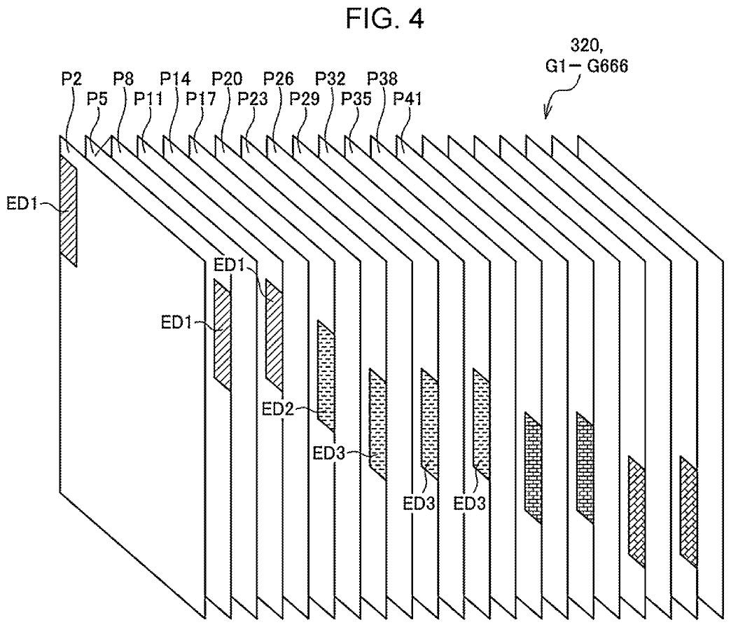

FIG. 4 is a screen diagram illustrating an example of the edge index marks ED displayed in the second image bundle 320 displayed in the second area AR2.

As described with reference to FIG. 2, the display controller 124 displays the images PM included in the second area AR2 for every preset odd number ND of images PM and hides some of the images PM in the second area AR2. The odd number ND is three in FIG. 4.

As illustrated in FIG. 4, the display controller 124 displays, as the second image bundle 320, for example, the images P2, P5, P8, P11, P14, P17, P20, P23, P26, P29, P32, P35, P38, and P41 successively from left to right.

As described with reference to FIG. 3, an edge index mark ED is attached to an even-numbered page image PEV at its left edge and the edge index mark ED is attached to an odd-numbered page image POD at its right edge.

The first edge index marks ED1 are attached to the images P1 to P11, the second edge index marks ED2 are attached to the images P12 to P21, and the third edge index marks ED3 are attached to the images P22 to P36.

As illustrated in FIG. 4, in the second image bundle 320, the first edge index marks ED1 attached to the image P5 and the image P11 are displayed in the front of the screen and are therefore visible to the user. The second edge index mark ED2 attached to the image P17 is displayed in the front of the screen and are therefore visible to the user. The third edge index marks ED3 attached to the images P23, P29, and P35 are displayed in the front of the screen and are therefore visible to the user.

The first edge index mark ED1 attached to the image P8 is arranged in the back of the screen and is therefore invisible to the user. The second edge index marks ED2 attached to the images P14 and P20 are arranged in the back of the screen and are therefore invisible to the user. The third edge index marks ED3 attached to the images P26 and P32 are arranged in the back of the screen and are therefore invisible to the user.

In such a manner, the display controller 124 displays the images PM included in the second area AR2 for every three images PM and hides the other images PM in the second area AR2. The images PM on odd-numbered pages and the images PM on even-numbered pages are alternately selected as the images PM to be displayed. In FIG. 4, the edge index marks ED attached to images PM on the odd-numbered pages are displayed in the front of the screen. The decrease in visibility of the edge index marks ED of the second image bundle 320 may be reduced.

Although FIG. 3 illustrates the case where an edge index mark ED is attached to an even-numbered page image PEV at its left edge and the edge index mark ED is attached to an odd-numbered page image POD at its right edge, the present disclosure is not limited to such. An embodiment may be such that the edge index mark ED is attached to the even-numbered page image PEV at its right edge and the edge index mark ED is attached to the odd-numbered page image POD at its left edge.

In this case, in the second image bundle 320, the edge index marks ED attached to the even-numbered images PM are displayed in the front of the screen and are therefore visible to the user. Accordingly, the decrease in visibility of the edge index marks ED of the second image bundle 320 may be reduced.

As illustrated in FIG. 4, since the images PM included in the second area AR2 are displayed for every odd number ND of images PM and the other images PM in the second area AR2 are hidden, the images PM on the odd-numbered pages and the images PM on the even-numbered pages are alternately displayed. In the second image bundle 320, the edge index marks ED attached to the images PM on the odd-numbered pages or the images PM on the even-numbered pages are displayed in the front of the screen and are therefore visible to the user. The decrease in visibility of the edge index marks ED of the second image bundle 320 may be reduced.

Next, with reference to FIGS. 5 and 6, the case where an instruction for scrolling the image bundle 300 in a given direction is issued through a user operation will be described.

FIG. 5 is a screen diagram illustrating an example of a scroll operation on the image bundle 300. FIG. 5 is a screen diagram illustrating the state prior to issuance of the instruction for scrolling.

In FIG. 5, the image bundle 300 that is the same as the image bundle 300 illustrated in FIG. 2 is displayed. In the first area AR1, the first image bundle 310 is displayed, and the first image bundle 310 is comprised of the images P667 to P675.

The user touches the display surface of the display 141 at the position of a finger H1, moves the finger in the rightward direction, which is the negative direction of the X-axis, to the position of a finger H2 while touching the display surface, and, at the position of the finger H2, removes the finger from the display surface of the display 141.

Here, the given direction is the rightward direction that is the negative direction of the X-axis.

The position of the finger H1 is the position of the image P670 displayed in the first area AR1 of the first image bundle 310. The position of the finger H2 is the position of the image P673 displayed in the first area AR1 of the first image bundle 310. The scroll operation is an operation of moving the image PM displayed in the first area AR1 to the right by a distance corresponding to three images PM.

FIG. 6 is a screen diagram illustrating an example of the image bundle 300 after the scroll operation illustrated in FIG. 5 has been performed. Since the scroll operation is an operation of moving the image PM displayed in the first area AR1 to the right by a distance corresponding to three images PM, the images PM displayed in the first area AR1 in FIG. 6 involves changes as follows.

The display controller 124 moves the image P667 in FIG. 5 to the position of the image P670. In FIG. 6, the image P667 is displayed at the position of the image P670 in FIG. 5. The display controller 124 moves the image P668 in FIG. 5 to the position of the image P671. In FIG. 6, the image P668 is displayed at the position of the image P671 in FIG. 5.

The display controller 124 moves the image P669 in FIG. 5 to the position of the image P672. In FIG. 6, the image P669 is displayed at the position of the image P672 in FIG. 5. The display controller 124 moves the image P670 in FIG. 5 to the position of the image P673. In FIG. 6, the image P670 is displayed at the position of the image P673 in FIG. 5.

The display controller 124 moves the image P671 in FIG. 5 to the position of the image P674. In FIG. 6, the image P671 is displayed at the position of the image P674 in FIG. 5. The display controller 124 moves the image P672 in FIG. 5 to the position of the image P675. In FIG. 6, the image P672 is displayed at the position of the image P675 in FIG. 5.

The display controller 124 moves the images P673 to P675 in FIG. 5 into the third image bundle 330 displayed in the third area AR3. The images P673, P674, and P675 illustrated in FIG. 5 become included in the third image bundle 330 displayed in the third area AR3 in FIG. 6.

The display controller 124 moves the images P664, P665, and P666 included in the second image bundle 320 displayed in the second area AR2 in FIG. 5 to the positions of the images P667, P668, and P669 in the first area AR1, respectively.

The display controller 124 moves the image P666, which is the image PM included in the second image bundle 320 displayed in the second area AR2 and closest to the first area AR1 in FIG. 5, to the position of the image P669 in FIG. 5. In FIG. 6, the image P666 is displayed at the position of the image P669 in FIG. 5.

The display controller 124 moves the image P665, which is the image PM included in the second image bundle 320 displayed in the second area AR2 and second closest to the first area AR1 in FIG. 5, to the position of the image P668 in FIG. 5. In FIG. 6, the image P665 is displayed at the position of the image P668 in FIG. 5. The display controller 124 moves the image P664, which is the image PM included in the second image bundle 320 displayed in the second area AR2 and third closest to the first area AR1 in FIG. 5, to the position of the image P667 in FIG. 5. In FIG. 6, the image P664 is displayed at the position of the image P667 in FIG. 5.

As described with reference to FIG. 2, the display controller 124 displays, of the images PM included in the second area AR2, up to ((the third threshold number NS3)−1) of images PM, that is, up to 10 images PM from the image PM closest to the first area AR1.

The closest image PM to the first area AR1, the second closest image PM, and the third closest image PM that are included in the second image bundle 320 displayed in the second area AR2 in FIG. 5 are displayed by the display controller 124. When the images PM displayed in the second area AR2 are moved to the first area AR1, the hidden images PM may be less likely to be moved and displayed in the first area AR1. As a result, natural image movement may be displayed.

Although the present embodiment describes the case where the display controller 124 displays, of the images PM included in the second area AR2, up to ((the third threshold number NS3)−1) of images PM, that is, up to 10 images PM from the image PM closest to the first area AR1, the present disclosure is not limited to such. For all the images PM included in the second area AR2, the display controller 124 may display the images PM included in the second area AR2 for every preset odd number ND of images PM and hide the other images PM in the second area AR2. In this case, a drawing process of the images PM moved from the second area AR2 to the first area AR1 is performed while these images PM are moving, and the images PM are changed from the hidden state to the displayed state by the display controller 124.

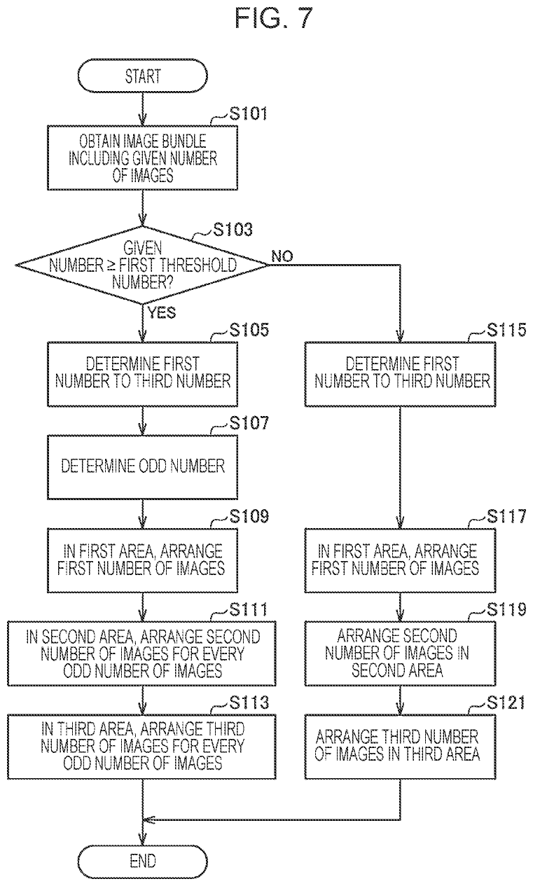

FIG. 7 is a flowchart illustrating an example of a process of the controller 11.

As illustrated in FIG. 7, in step S101, the obtainer 121 obtains the document information DC from the server apparatus 2. The generator 122 generates the image bundle 300 corresponding to the document information DC. The image bundle 300 includes the given number N of images PM. The given number N is, for example, 1000.

After the generator 122 has generated the image bundle 300, in step S103, the determiner 123 determines whether the given number N is greater than or equal to the first threshold number NS1. The first threshold number NS1 is, for example, 300.

When the determiner 123 determines that the given number N is not greater than or equal to the first threshold number NS1 (No in step S103), the process proceeds to step S115. When the determiner 123 determines that the given number N is greater than or equal to the first threshold number NS1 (Yes in step S103), the process proceeds to step S105.

In step S105, the controller 11 determines the first number N1, the second number N2, and the third number N3. For example, the first number N1 is nine, the second number N2 is 666, and the third number N3 is 325.

After having determined the first number N1, the second number N2, and the third number N3, in step S107, the controller 11 determines the odd number ND. The odd number ND is, for example, three.

After the controller 11 has determined the odd number ND, in step S109, the display controller 124 displays, in the first area AR1, the first image bundle 310 in which the first number N1 of images PM are arranged apart. The two adjacent images PM included in the first number N1 of images PM are arranged apart with the first interval ΔL1.

In step S111, the display controller 124 displays, in the second area AR2, the second image bundle 320 in which a drawing process of the second number N2 of images PM displayed for every odd number ND of images PM is performed and the second number N2 of images PM displayed for every odd number ND of images PM are arranged apart with the second interval ΔL2 in an overlapping manner. The first interval ΔL1 is greater than the second interval ΔL2.

In step S113, the display controller 124 displays, in the third area AR3, the third image bundle 330 in which a drawing process of the third number N3 of images PM displayed for every odd number ND of images PM is performed and the third number N3 of images PM displayed for every odd number ND of images PM are arranged apart with the second interval ΔL2 in an overlapping manner. Then, the process terminates.

When No in step S103, in step S115, the controller 11 determines the first number N1, the second number N2, and the third number N3.

After the controller 11 has determined the first number N1, the second number N2, and the third number N3, in step S117, the display controller 124 displays, in the first area AR1, the first image bundle 310 in which the first number N1 of images PM are arranged apart. The two adjacent images PM included in the first number N1 of images PM are arranged apart with the first interval ΔL1.

In step S119, the display controller 124 displays, in the second area AR2, the second image bundle 320 in which the second number N2 of images PM are arranged apart with the second interval ΔL2 in an overlapping manner.

In step S121, the display controller 124 displays, in the third area AR3, the third image bundle 330 in which the third number N3 of images PM are arranged apart with the second interval ΔL2 in an overlapping manner. Then, the process terminates.

As described with reference to FIG. 7, when the given number N is greater than or equal to the first threshold number NS1, the display controller 124 displays the images PM in the second area AR2 for every odd number ND of images PM and hides the other images PM in the second area AR2. As the images PM to be displayed in the second area AR2, the images PM on the odd-numbered pages and the images PM on the even-numbered pages are alternately selected. The display controller 124 hides some of the images PM included in the second area AR2 and thus the decrease in visibility of the second image bundle 320 may be reduced.

Hiding some of the images PM in the second area AR2 may reduce the memory capacity to be used for displaying the second image bundle 320 and the processing amount.

As described above with reference to FIGS. 1 to 8, the display control method for the smartphone 1 according to the present embodiment is a display control method for displaying, along a virtual axis, the given number N of images PM in the image bundle 300 including the first area AR1 and the second area AR2. In the first area AR1, the first number N1, less than the given number N, of images PM are arranged apart. The two adjacent images PM included in the first number N1 of images PM are arranged apart with the first interval ΔL1. In the second area AR2, the second number N2, less than the given number N, of images PM are arranged apart with the second interval ΔL2 in an overlapping manner. The first interval ΔL1 is greater than the second interval ΔL2. When the given number N is greater than the predetermined first threshold number NS1, some of the images PM in the second area AR2 are hidden.

In the second area AR2, when the given number N is greater than the predetermined first threshold number NS1, some of the images PM in the second area AR2 are hidden.

Hiding some of the images PM in the second area AR2 when the given number N is greater than the first threshold number NS1 may reduce the memory capacity to be used for displaying the images PM in the second area AR2, and the processing amount. When the given number N is greater than the first threshold number NS1, the time taken to display the images PM in the second area AR2, for which the content of the images PM is not able to be read, may be reduced.

In the display control method described above, some of the images PM in the second area AR2 are hidden according to a predetermined rule.

Since some of the images PM in the second area AR2 are hidden according to the predetermined rule, the smartphone 1 may effectively hide some of the images PM in the second area AR2.

In the display control method described above, some of the images PM in the second area AR2 are hidden such that the difference between the number of odd-numbered images PM to be displayed and the number of even-numbered images PM to be displayed, among the second number N2 of images PM, is less than or equal to the second threshold number NS2.

When edge index marks ED are attached to the images PM as illustrated in FIG. 3, with the smartphone 1, the difference between the number of edge index marks ED arranged in the front of the screen and the number of edge index marks ED arranged in the back of the screen may be less than or equal to the second threshold number NS2. With the smartphone 1, the likelihood that all the edge index marks ED attached to the images PM will not be displayed may be reduced.

In the display control method described above, the images PM included in the second area AR2 are displayed for every preset odd number ND of images PM, and thereby some of the images PM in the second area AR2 are hidden.

As illustrated in FIG. 4, the images PM on the odd-numbered pages and the images PM on the even-numbered pages are alternately displayed. Accordingly, there is an increase in the likelihood that the edge index marks ED attached to the images PM will be displayed.

In the display control method described above, of the images PM included in the second area AR2, the images PM apart from the image PM closest to the first area AR1 by the third threshold number NS3 or more of images PM are hidden according to a rule.

When the images PM displayed in the second area AR2 are moved to the first area AR1, the hidden images PM may be less likely to be moved and displayed in the first area AR1. This may result in a reduction in the display of unnatural image movement.

In the display control method described above, a drawing process of the images PM to be hidden is omitted.

The time taken to perform a drawing process of the images PM included in the second area AR2 may be reduced.

In the display control method described above, when an instruction for scrolling the image bundle 300 in a given direction is issued through a user operation, the images PM displayed in the second area AR2 are moved to the first area AR1.

Through a scroll operation in the given direction, the user may move the images PM displayed in the second area AR2 to the first area AR1. The user may move the images PM displayed in the second area AR2 to the first area AR1 to be able to display the content of the images PM in a readable manner.

In the display control method described above, when the images PM displayed in the second area AR2 are moved to the first area AR1, among the hidden images PM, the images PM to be moved from the second area AR2 to the first area AR1 are displayed.

When the images PM included in the second area AR2 and are hidden are moved from the second area AR2 to the first area AR1, the user may display the content of the images PM moved to the first area AR1 in a readable manner. The control program PGM according to the present embodiment is the control program PGM to be executed by the controller 11 of the smartphone 1. The control program PGM causes the controller 11 to function as the determiner 123 configured to determine whether the number of images included in the image bundle 300 to be displayed is greater than or equal to the first threshold number NS1, and the display controller 124 configured to display the image bundle 300 including the first area AR1 in which the first number N1, less than the given number N, of images PM are arranged apart, and the second area AR2 in which the second number N2, less than the given number N, of images PM are arranged apart with the second interval ΔL2 in an overlapping manner. The display controller 124 arranges two adjacent images PM included in the first number N1 of images PM apart with the first interval ΔL1. The first interval ΔL1 is greater than the second interval ΔL2. When the determiner 123 determines that the given number N is greater than or equal to the first threshold number NS1, the display controller 124 hides some of the images PM in the second area AR2.

With this configuration, the same advantageous effects as those of the display control method according to the present embodiment are attained.

The smartphone 1 according to the present embodiment includes the obtainer 121 configured to obtain the document information DC corresponding to the image bundle 300 including the given number N of images PM, the determiner 123 configured to determine whether the given number N is greater than the first threshold number NS1, and the display controller 124 configured to display the image bundle 300 including the first area AR1 in which the first number N1, less than the given number N, of images PM are arranged apart, and the second area AR2 in which the second number N2, less than the given number N, of images PM apart with the second interval ΔL2 in an overlapping manner. The display controller 124 arranges two adjacent images PM included in the first number N1 of images PM apart with the first interval ΔL1. The first interval ΔL1 is greater than the second interval ΔL2. When the determiner 123 determines that the given number N is greater than or equal to the first threshold number NS1, the display controller 124 hides some of the images PM in the second area AR2.

With this configuration, the same advantageous effects as those of the display control method according to the present embodiment are attained.

The present embodiment illustrates an aspect and may be arbitrarily modified and applied.

Although the present embodiment illustrates that the display control device is the smartphone 1, the present disclosure is not limited to this. It is sufficient that the display control device include the processor 12, the memory 13, and a display such as the display 141. The display control device may be constituted by, for example, a notebook computer or a tablet computer.

Although the present embodiment illustrates that the image bundle 300 consists of the first area AR1, the second area AR2, and the third area AR3, it is sufficient that the image bundle 300 include the first area AR1 and the second area AR2. The image bundle 300 may consist of the first area AR1 and the second area AR2.

The display control method according to the present embodiment is implemented when the processor 12 included in the smartphone 1 executes the control program PGM. However, the control program PGM that the processor 12 executes to implement the display control method may be provided in a computer-readable recording medium or a transmission medium for transmitting the control program PGM.

As the recording medium mentioned above, a magnetic or optical recording medium or a semiconductor memory device may be used. A portable or fixed recording medium such as a flexible disk, HDD, compact disk read-only memory (CD-ROM), digital versatile disk (DVD), Blu-ray (registered trademark) disc, magneto-optical disc, flash memory, or card type recording medium may be cited. The recording medium mentioned above may be a nonvolatile storage device, such as a RAM, ROM, or HDD, which is an internal storage device included in the smartphone 1.

The functions of the controller 11 may be implemented by one or more processors or a semiconductor chip. The controller 11 may be configured to further include a coprocessor, such as a system-on-a-chip (SoC), micro control unit (MCU), or field-programmable gate array (FPGA). The controller 11 may perform various kinds of control by causing both of the CPU and the coprocessor to cooperate together or selectively using one of both.

The process units of the flowchart in FIG. 7 are those into which processing of the controller 11 is divided according to the main process content for ease of understanding and will not be limited by how the processing is divided into the process units and what are the names of the process units. The process units of the flowchart may also be divided into more process units according to the process content. The process units of the flowchart may also be divided such that one process unit includes more processes. The processing order may be changed appropriately without departing from the sprit and scope of the present disclosure.

The functional units illustrated in FIG. 1 indicate the functional configuration, and their implementation forms are not particularly limited. Hardware individually corresponding to each functional unit need not be implemented, and the configuration may be such that the functions of a plurality of functional units are implemented by a single processor executing programs. Some of the functions implemented by software in the embodiment described above may be hardware. Alternatively, some of the functions implemented by hardware may be implemented by software. In addition, the specific detailed configurations of the other components of the smartphone 1 may be changed to any configurations without departing from the gist thereof.

What is claimed is:

1. A display control method for displaying, along a virtual axis, a given number of images in an image bundle including a first area and a second area, the display control method comprising:
arranging two adjacent images in the first area apart with a first interval, the first area including a first number of the images, the first number being less than the given number;
arranging two adjacent images in the second area apart with a second interval in an overlapping manner, the second area including a second number of the images, the second number being less than the given number, the first interval being greater than the second interval; and
hiding some of the images in the second area when the given number is greater than a predetermined first threshold number.

2. The display control method according to claim 1, wherein
some of the images in the second area are hidden according to a predetermined rule.

3. The display control method according to claim 2, wherein
when some of the images in the second area are hidden, a difference between a number of odd-numbered images to be displayed and a number of even-numbered images to be displayed, among the second number of the images, is less than or equal to a second threshold number.

4. The display control method according to claim 2, wherein
when some of the images in the second area are hidden, the images in the second area are displayed for every preset odd number of the images.

5. The display control method according to claim 2, wherein
among the images in the second area, the images apart from an image closest to the first area by a third threshold number or more of the images are hidden according to the rule.

6. The display control method according to claim 1, wherein
a drawing process of the images to be hidden is omitted.

7. The display control method according to claim 1, further comprising:
moving the images displayed in the second area to the first area when an instruction for scrolling the image bundle in a given direction is issued through a user operation.

8. The display control method according to claim 7, wherein
when the images displayed in the second area are moved to the first area, among the hidden images, the images moved from the second area to the first area are displayed.

9. A non-transitory computer-readable storage medium storing a display control program that, when executed by a computer of a display control device, causes the computer to function as:
a determiner configured to determine whether a number of images included in an image bundle to be displayed is greater than or equal to a first threshold number; and
a display controller configured to display an image bundle including a first area in which a first number of images are arranged apart, the first number being less than the number of images, and a second area in which a second number of images are arranged apart with a second interval in an overlapping manner, the second number being less than the number of images, wherein
the display controller arranges two adjacent images in the first area apart with a first interval,
the first interval is greater than the second interval, and
the display controller hides some of the images in the second area when the determiner determines that the number of images is greater than or equal to the first threshold number.

10. A display control device comprising:
an obtainer configured to obtain an image bundle including a given number of images;
a determiner configured to determine whether the given number is greater than or equal to a predetermined first threshold number; and
a display controller configured to display an image bundle including a first area in which a first number of images are arranged apart, the first number being less than the given number, and a second area in which a second number of images are arranged apart with a second interval in an overlapping manner, the second number being less than the given number, wherein
the display controller arranges two adjacent images in the first area apart with a first interval,
the first interval is greater than the second interval, and
the display controller hides some of the images in the second area when the determiner determines that the given number is greater than or equal to the first threshold number.
